(19) United States
(12) Patent Application Publication
(10) Pub. No.: US 2001/0009587 A1
(43) Pub. Date: Jul. 26, 2001

(54) Electroacoustic miniature transducer

(75) Inventor: Torsten Niederdrank, Erlangen (DE)

Correspondence Address: SCHIFF HARDIN & WAITE, Patent Department, 6600 Sears Tower, Chicago, IL, 60606-6473, US

(73) Assignee: Siemens Audiologische Technik GmbH

(21) Appl. No.: 09/766,918

(22) Filed: Jan. 22, 2001

(30) Foreign Application Priority Data
Jan. 21, 2000 (DE) 100 02 567.6

(51) Int. Cl. H04R 1/00; H04R 9/06; H04R 11/02

(52) U.S. Cl. 381/423; 381/431

(57) ABSTRACT

An electroacoustic miniature transducer has at least one drive and one membrane. The membrane is divided into a number of membrane regions. For the connection of two adjacent membrane regions, an elastic element is arranged between these regions. This transducer design achieves an expansion of the transmission characteristic of the miniature transducer as high frequencies are approached.

### BACKGROUND OF THE INVENTION

1. Field of the Invention

The present invention relates to an electroacoustic miniature transducer

2. Description of the Prior Art

Electroacoustic miniature transducers are used to convert electrical signals into acoustic signals. In many areas of application, such as for example in hearing aids, acoustic output signals are produced by electroacoustic transducers having a small structural form, known as earpieces or earphones. In this context, besides the smallest possible structural form, important factors are the degree of efficiency, an amount of distortion that is minimal and non-linear, and, above all, the transmission characteristic of the transducer. Thus, for example, in hearing aids a frequency characteristic that is equalized and that is adapted to the application is of great importance. The limits of the transmission characteristic of known electroacoustic miniature transducers as high frequencies are approached are determined by the structural transducer design, and in general represent an upper limit for the frequency range that can be transmitted.

From German OS 199 14 235, a miniature transducer for a hearing aid is known that is constructed for complete insertion into the ear canal. The transducer has a housing that defines an interior space from an exterior space, as well as a motor (solenoid) having a coil, a stack, and an armature that are essentially located inside the housing. The housing is formed by an upper cup that is connected with a lower cup and has an opening. The stack extends outward through the opening. The stack terminates with the housing. The housing has a base surface, and the opening is arranged on this base surface.

Commercially available electroacoustic miniature transducers of this type are for the most part based on the electromagnetic principle. A magnetic force acts on an armature, which is set into motion and drives a membrane via a mechanical connection. This transducer mechanism is built into a small housing. The choice of the enclosed air volume, the connection channels, and the masses and spring characteristics of the mechanical components constitute a resonant system whose resonances are decisive for the determination of the transmission characteristic of the miniature transducer (I. Veit, Technische Akustik, Vogel Verlag Würzburg, 1978).

Above the highest resonance frequency, the behavior of the transducer system is mass-determined, and the transmission characteristic exhibits a sharp decrease of the radiated sound signals as high frequencies are approached.

### SUMMARY OF THE INVENTION

An object of the present invention is to improve the transmission characteristic of an electroacoustic miniature transducer.

This object is achieved in accordance with the invention an electroacoustic miniature transducer having at least one drive and one membrane, wherein the membrane is divided into at least two sound-producing membrane regions whose respective transmission characteristics are frequency-dependent.

The inventive electroacoustic miniature transducer offers a transmission range that is expanded as high frequencies are approached. A natural spectrum of the acoustic signals thus can be transmitted, and an improved sound quality can be obtained. For this purpose, instead of a relatively large one-piece membrane, the inventive electroacoustic miniature transducer has a membrane that is divided into at least two smaller membrane regions. For the division of the membrane, at least one elastic element connected with the membrane regions is, for example, located between each two adjacent membrane regions. The overall surface of the membrane regions and elastic elements thus can correspond to the membrane surface of a conventional miniature transducer. For driving the membrane, a membrane region is preferably connected with a drive pin. Corresponding to the prior art, the drive takes place via an electromagnetic, electrodynamic, or piezoelectric drive. High frequencies are essentially radiated only by the directly driven membrane region. Due to the relatively small sound-producing membrane surface and the small driven mass connected therewith, at high frequencies the inventive membrane is very much less mass-dependent than is the membrane of known miniature transducers. At lower frequencies, according to the invention the membrane region adjacent to the driven membrane region is also excited in such a way that this region also acts as a producer of sound. The sound-producing membrane surface therefore essentially corresponds at low frequencies to the membrane surface of a conventional miniature transducer. The division of the transducer membrane thus effects a dynamic reduction of the moved masses in the membrane region, and thus provides for the reduced hindrance due to mass at higher frequencies. The transmission characteristic of the miniature transducer according to the invention is therefore comparable to the transmission characteristic of known miniature transducers at low and middle frequencies, whereas the transmission range as high frequencies are approached is advantageously expanded in the miniature transducer according to the invention.

### DESCRIPTION OF THE DRAWINGS

FIG. 1 shows the membrane of a miniature transducer according to the invention.

FIG. 2 shows the transmission characteristics of two miniature transducers according to the invention.

FIG. 3 shows the block diagram of a hearing aid having a miniature transducer according to the invention.

### DESCRIPTION OF THE PREFERRED EMBODIMENTS

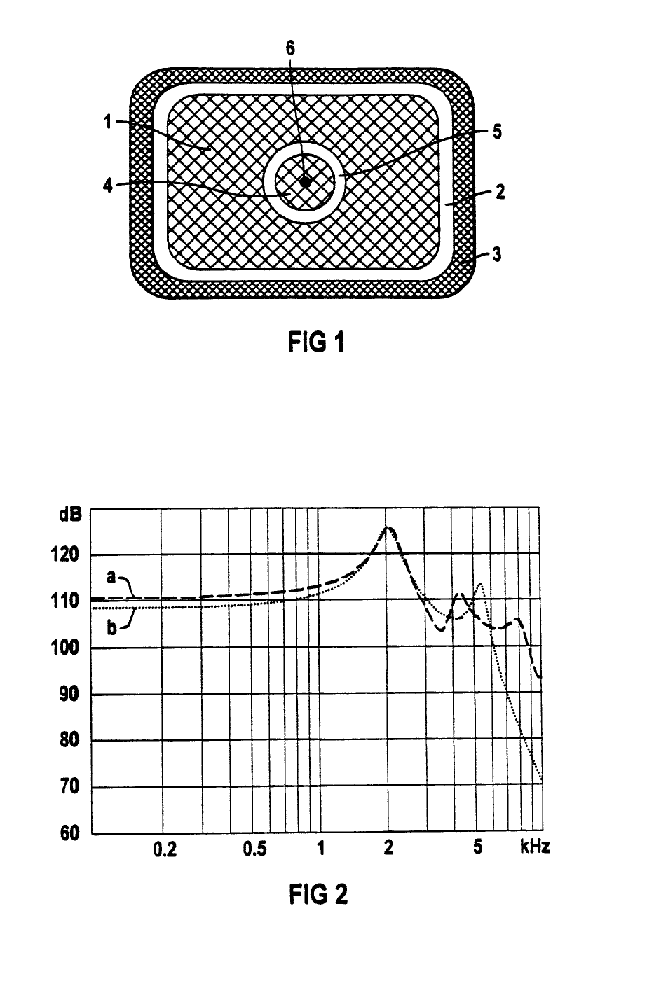

In FIG. 1, as an example the divided membrane of a miniature transducer according to the invention is shown. A membrane region 1 is connected by a bead 2 with a frame element on the housing 3 of the miniature transducer. A second, smaller membrane region 4 is embedded in the larger membrane region 1 by an elastic element 5 having a beadlike consistency. The drive 6 connected directly with the smaller membrane region 4 is located in the center of the membrane. This drive can for example be realized as a tappet or plunger on which the armature of an electromagnetic transducer system acts. Given a corresponding tuning of the mechanical resonance system, consisting essentially of the spring action of the elastic element 5, the bead 2, and the masses of the membrane regions 1 and 4, in the lower and middle frequency range there results a uniform movement of the overall membrane surface. In the higher frequency range, the membrane region 1 is damped by its mass, while the membrane region 4 continue to radiate. The dynamic reduction way of the moved masses in the membrane region which is thereby achieved provides for a reduced damping due to mass at higher frequencies in the miniature transducer according to the invention. The high-frequency transmission characteristics of the miniature transducer are therefore significantly improved in comparison to known miniature transducers. The membrane arrangement is built in a known way into a housing provided with various chambers and channels, which to a large extent predetermine the overall transmission characteristic.

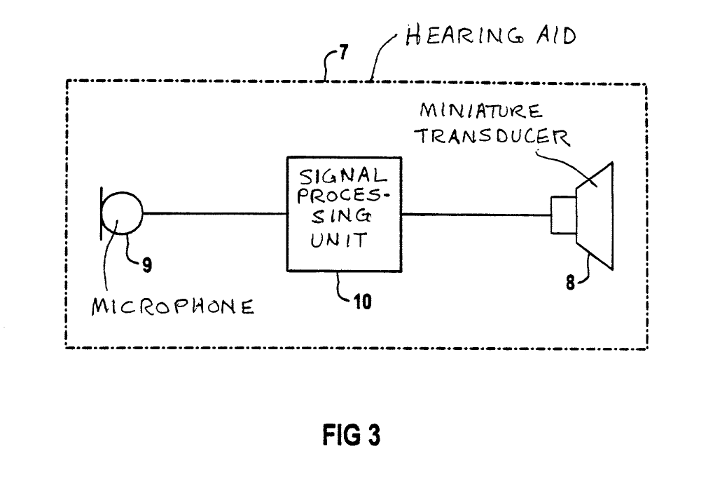

FIG. 2 illustrates the advantages that can be achieved by the invention. FIG. 2 compares the transmission characteristic of a known hearing aid (characteristic line b, dotted) with a miniature transducer of the same design, which however has a membrane divided into two sound-producing membrane regions, according to FIG. 1 (characteristic line a, broken). Examination of the transmission characteristics of the miniature transducer according to the invention (characteristic line a) clearly reveals the expansion of the transmission range at higher frequencies. As shown in FIG. 3, the miniature transducer can in particular be used in a hearing aid 7 that has, in addition to the miniature transducer 8, at least one microphone 9, as well as a signal processing unit 10.

The invention is not limited to the exemplary embodiment, but rather can be expanded by a large number of variants without departing from the basic idea of the invention. For example, it is possible to divide the membrane into more than two regions. A rectangular membrane structure is also possible, in which the membrane regions are arranged alongside one another in a row. In this case as well, the connection of adjacent membrane regions takes place via a respective elastic element located between these regions. The excitation of the membrane can also take place outside the center, for example at the edge.

Although modifications and changes may be suggested by those skilled in the art, it is the intention of the inventor to embody within the patent warranted hereon all changes and modifications as reasonably and properly come within the scope of his contribution to the art.

I claim as my invention:

1. A miniature electroacoustic transducer comprising:
a membrane;
a drive element in contact with said membrane for mechanically driving said membrane to cause said membrane to radiate acoustic waves; and
said membrane being divided into at least two sound-producing membrane regions having respective frequency-dependent transmission characteristics.

2. A miniature electroacoustic transducer as claimed in claim 1 wherein said membrane regions include adjacent membrane regions, and wherein said membrane comprises an elastic element disposed between adjacent membrane regions.

3. A miniature electroacoustic transducer as claimed in claim 2 wherein said membrane regions and said elastic element form a mechanically-resonant system.

4. A miniature electroacoustic transducer as claimed in claim 1 wherein said membrane regions are annularly disposed around a common symmetry axis.

5. A miniature electroacoustic transducer as claimed in claim 4 wherein said membrane regions include a center membrane region which is mechanically connected to said drive.
